(19) United States
(12) Patent Application Publication
(10) Pub. No.: US 2018/0206410 A1
(43) Pub. Date: Jul. 26, 2018

(54) HEDGE TRIMMER

(71) Applicant: Nanjing Chervon Industry Co., Ltd., Nanjing (CN)

(72) Inventors: Rubao Liu, Nanjing (CN); Fei Wang, Nanjing (CN)

(21) Appl. No.: 15/877,794

(22) Filed: Jan. 23, 2018

(30) Foreign Application Priority Data
Jan. 24, 2017 (CN) 201720095300.1

(51) Int. Cl. A01G 3/053

(52) U.S. Cl. CPC A01G 3/053

(57) ABSTRACT

A hedge trimmer includes a motor, a first blade, a second blade, a support bar, limiting elements, buffer gaskets and connecting rods. The first blade is formed with first installing holes. The second blade is formed with second installing holes. The support bar extends along a longitudinal direction and is configured to install the first blade and the second blade. The motor drives the first blade. Each limiting element is provided with a limiting plane. Each buffer gasket is formed with a connecting hole. Each connecting rod is connected to one of the limiting elements after successively penetrating through one of the second installing holes, one of the first installing holes and the connecting hole along a predetermined direction perpendicular to the longitudinal direction. A distance from the limiting plane to the first blade is greater than a thickness of one of the buffer gaskets.

### RELATED APPLICATION INFORMATION

This application claims the benefit under 35 U.S.C. § 119(a) of Chinese Patent Application No. CN 201720095300.1, filed on Jan. 24, 2017, which is incorporated by reference in its entirety herein.

### TECHNICAL FIELD

The present disclosure relates generally to garden tools and, more particularly, to a hedge trimmer.

### BACKGROUND

A hedge trimmer is a garden tool used mainly for a gardening work such as trimming of hedges and pruning of roadside trees. The hedge trimmer includes two blades. A motor drives at least one blade to make reciprocating motion relative to the other blade, thereby implementing cutting.

The hedge trimmer includes a limiting element for limiting relative positions of the two blades. In a typical hedge trimmer, the blades may directly abrade the limiting element during motion, causing loosening and even separating the limiting element due to rotation of the limiting element. Thus, the two blades become away from each other, thereby decreasing cutting performance.

### SUMMARY

In one aspect of the disclosure, a hedge trimmer includes a first blade formed with a plurality of first cutting edges for cutting and formed with a plurality of first installing holes extending through the first blade along a predetermined direction,

a second blade formed with a plurality of second cutting edges for cutting and formed with a plurality of second installing holes extending through the second blade along the predetermined direction, and a support bar configured to install the first blade and the second blade and extending along a longitudinal direction perpendicular to the predetermined direction, a motor capable of driving the first blade to make reciprocating motion along the longitudinal direction, a plurality of limiting elements, and each limiting element is provided with a limiting plane, wherein a projection of the limiting plane in a plane perpendicular to the predetermined direction at least partially exceeds a projection of one of the first installing holes in the plane perpendicular to the predetermined direction, a plurality of buffer gaskets, each of which is formed with a connecting hole, and a plurality of connecting rods, each of which is connected to one of the limiting elements after successively penetrating through one of the second installing holes, one of the first installing holes and the connecting hole along the predetermined direction, wherein a distance from the limiting plane to the first blade is greater than a thickness of one of the buffer gaskets.

Further, the hedge trimmer may include bushings, each of which is formed with a second fixing hole, wherein each of the bushings successively penetrates through one of the second installing holes, one of the first installing holes and the connecting hole along the predetermined direction, one end of each of the bushings contacts with the limiting plane, the connecting rod penetrates through the second fixing hole along the predetermined direction, and each of the bushings is arranged between the limiting plane and the support bar.

Further, the hedge trimmer may include a scaleboard arranged between each of the bushings and the support bar wherein the scaleboard is formed with third fixing holes, the connecting rod penetrates through one of the third fixing holes, and both end surfaces of the scaleboard respectively contact with the bushings and the support bar.

Further, a hardness of the scaleboard may be greater than a hardness of the support bar.

Further, the limiting elements may be gaskets, each of the limiting elements is formed with a first fixing hole, the connecting rod penetrates through the first fixing hole, and a thickness of each of the buffer gaskets is less than a thickness of each of the limiting elements.

Further, a hardness of each of the buffer gaskets may be greater than or equal to 30HRC.

Further, a surface roughness of each of the buffer gaskets may be smaller than 0.8 um.

Further, the thickness of each of the buffer gaskets may be greater than or equal to 0.1 mm and less than or equal to 1 mm.

Further, the hedge trimmer may include bolts, each of which includes a screw rod provided with screw thread and a head arranged on one end of the screw rod wherein the screw rod is used as a connecting rod, and nuts, each of which is combined to the screw rod, and wherein the first blade and the second blade are located between heads of the bolts and the nuts.

Further, the support bar may be formed with an installing groove matched with heads of the bolts and the heads of the bolts are arranged in the installing groove.

In another aspect of the disclosure, a hedge trimmer may include a motor, a first blade formed with a plurality of first cutting edges for cutting and formed with first installing holes, a second blade formed with a plurality of second cutting edges for cutting and formed with second installing holes, and a support bar configured to install the first blade and the second blade and extending along a longitudinal direction, wherein the motor drives the first blade to make reciprocating motion along the longitudinal direction, the first blade is formed with the first installing holes penetrating through the first blade along a predetermined direction perpendicular to the longitudinal direction, and the second blade is formed with the second installing holes penetrating through the second blade along the predetermined direction. The hedge trimmer may further include limiting gaskets, each of which is provided with a limiting plane, wherein a projection of the limiting plane in a plane perpendicular to the predetermined direction at least partially exceeds a projection of one of the first installing holes in the plane perpendicular to the predetermined direction and each of the limiting gaskets is formed with a first fixing hole, bushings, each of which is formed with a second fixing hole, wherein each of the bushings successively penetrates through one of the second installing holes, one of the first installing holes and the connecting hole along the predetermined direction, bolts, each of which includes a screw rod provided with screw thread and a head arranged on one end of the screw rod, wherein the screw rod of each of the bolts penetrates through the first fixing hole and the second fixing hole along the predetermined direction, buffer gaskets, each of which is formed with a connecting hole, and nuts, each of which is combined to the screw rod, wherein a distance from the limiting plane to the first blade is greater than a thickness of each of the buffer gaskets, the limiting gaskets are located between the nuts and the bushings, and both ends of each of the limiting gaskets respectively contact with one of the nuts and one of the bushings.

Further, the hedge trimmer further may include a scaleboard arranged between each of the bushings and the support bar, the scaleboard is formed with third fixing holes, the screw rod of each of the bolts penetrates through each of the third fixing holes, and both end surfaces of the scaleboard respectively contact with the bushings and the support bar.

Further, a hardness of the scaleboard may be greater than a hardness of the support bar.

Further, a thickness of each of the buffer gaskets may be less than a thickness of each of the limiting gaskets.

Further, the support bar may be formed with an installing groove matched with heads of the bolts and the heads of the bolts are arranged in the installing groove.

Further, a hardness of each of the buffer gaskets may be greater than or equal to 30HRC and a surface roughness of each of the buffer gaskets may be smaller than 0.8 um.

In another aspect of the disclosure, a hedge trimmer may include a motor, a first blade formed with a plurality of first cutting edges for cutting and formed with first installing holes, a second blade formed with a plurality of second cutting edges for cutting and formed with second installing holes, and a support bar configured to install the first blade and the second blade and extending along a longitudinal direction, wherein the motor drives the first blade to make reciprocating motion along the longitudinal direction, the first blade is formed with the first installing holes penetrating through the first blade along a predetermined direction perpendicular to the longitudinal direction, and the second blade is formed with the second installing holes penetrating through the second blade along the predetermined direction. The hedge trimmer may further include limiting gaskets, each of which is provided with a limiting plane, wherein a projection of the limiting plane in a plane perpendicular to the predetermined direction at least partially exceeds a projection of one of the first installing holes in the plane perpendicular to the predetermined direction, and each of the limiting gaskets is formed with a first fixing hole, bushings, each of which is formed with a second fixing hole, bolts, each of which includes a screw rod provided with screw thread and a head arranged on one end of the screw rod, wherein the screw rod of each of the bolts penetrates through the first fixing hole and the second fixing hole along the predetermined direction, buffer gaskets, each of which is formed with a connecting hole, and nuts, each of which is combined to the screw rod, wherein each of the bushings successively penetrates through one of the second installing holes, one of the first installing holes and the connecting hole along the predetermined direction, a distance from the limiting plane to the first blade is greater than a thickness of each of the buffer gaskets, each of the limiting gaskets is located between the head and one of the bushings, and both ends of each of the limiting gaskets respectively contact with the head and one of the bushings.

Further, the hedge trimmer may further include a scaleboard arranged between each of the bushings and the support bar wherein the scaleboard is formed with third fixing holes, the screw rod of each of the bolts penetrates through each of the third fixing holes, and both end surfaces of the scaleboard respectively contact with the bushings and the support bar.

Further, a hardness of the scaleboard may be greater than a hardness of the support bar.

Further, a thickness of each of the buffer gaskets may be less than a thickness of each of the limiting gaskets.

In the hedge trimmer disclosed herein, movable buffer gaskets are arranged between the limiting plane and the first blade. In a movement process of the first blade, the first blade contacts and drives the buffer gaskets to move relative to the limiting plane and the buffer gaskets avoid direct transmitting of the action force of the first blade to the limiting plane and avoid loosening and separating of the limiting elements due to rotation of the limiting elements.

### BRIEF DESCRIPTION OF DRAWINGS

FIG. 1 is a schematic view illustrating an exemplary hedge trimmer;

FIG. 2 is a schematic view of an exemplary blade assembly of the hedge trimmer in FIG. 1;

FIG. 3 is an exploded view of the blade assembly in FIG. 2;

FIG. 4 is an exploded view of another visual angle of the blade assembly in FIG. 2;

FIG. 5 is an enlarged view of part of a structure in FIG. 4;

FIG. 6 is an schematic assembled view of the blade assembly in FIG. 5;

FIG. 7 is an exploded view of another exemplary blade assembly;

FIG. 8 is an enlarged view illustrating part of a structure of the blade assembly in FIG. 7; and

FIG. 9 is a schematic assembled view of the blade assembly in FIG. 7.

### DETAILED DESCRIPTION

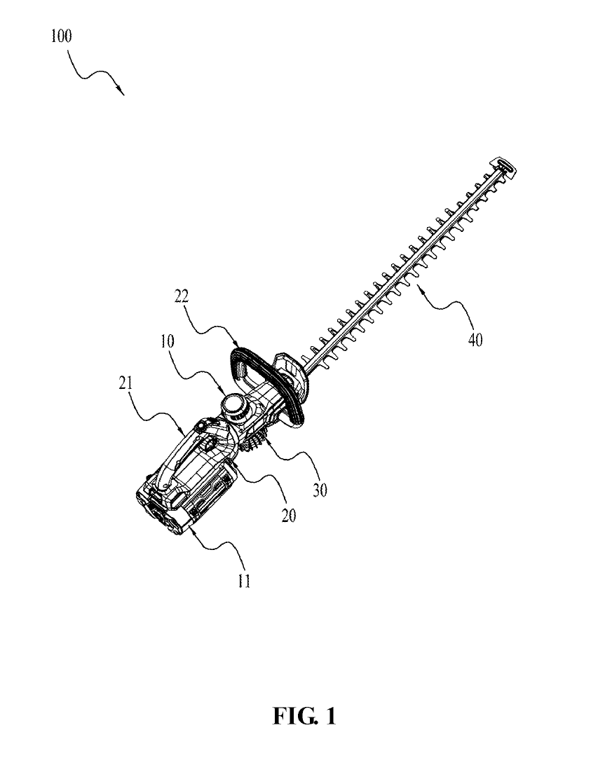

Referring to FIG. 1, a hedge trimmer 100 includes a motor 10, a housing 20, a transmission mechanism 30 and a blade assembly 40.

The motor 10 is mounted on the housing 20. The blade assembly 40 implements a cutting function. The transmission mechanism 30 transmits power of the motor 10 to the blade assembly 40. The motor 10 may be an internal combustion engine using fuel combustion as power and may be a motor using electricity as power. In the illustrated example, the motor 10 is an electrical motor, and the hedge trimmer 100 further includes a battery pack 11. The battery pack 11 is electrically connected to the motor 10 for supplying electricity for the motor 10. The battery pack 11 is detachably mounted to the housing 20. The housing 20 is formed with a main handle 21 for a user to hold. The hedge trimmer 100 further includes an auxiliary handle 22 for the user to hold. The user can hold the main handle 21 and the auxiliary handle 22 respectively with both hands. The motor 10 is arranged between the main handle 21 and the auxiliary handle 22.

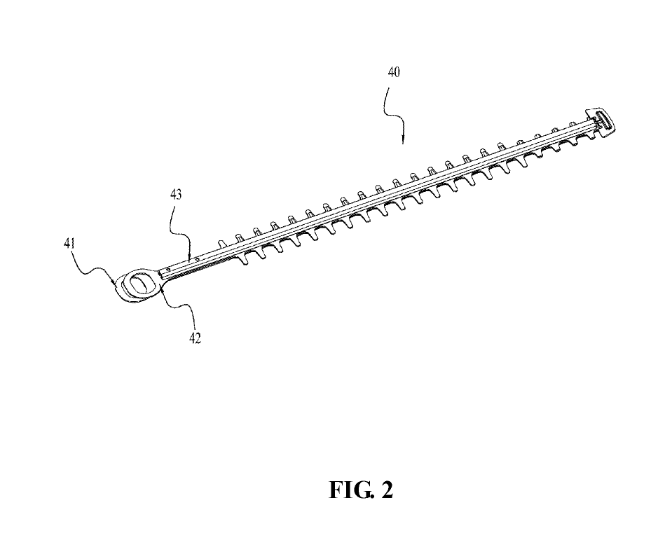

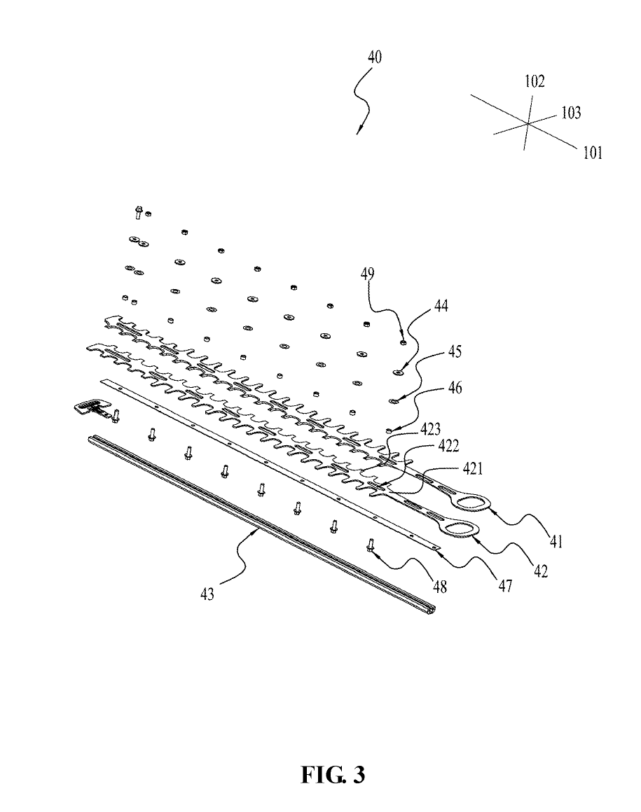

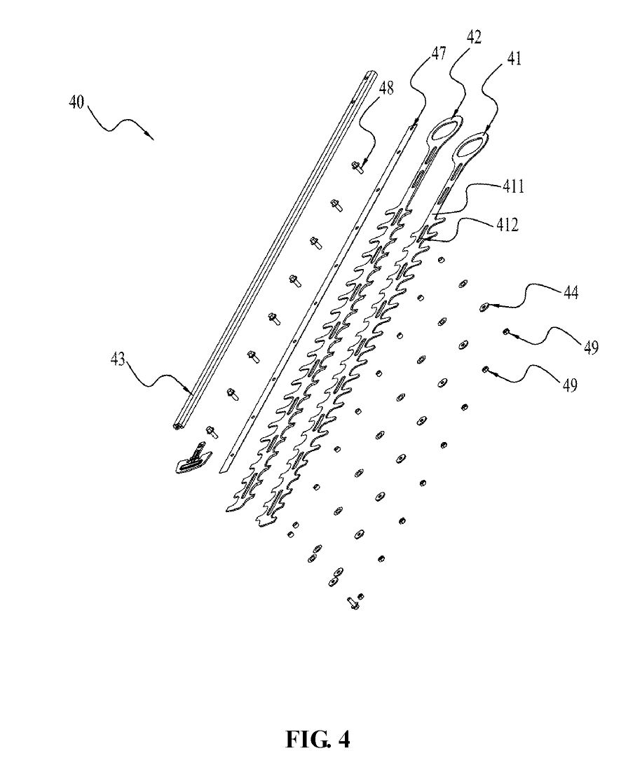

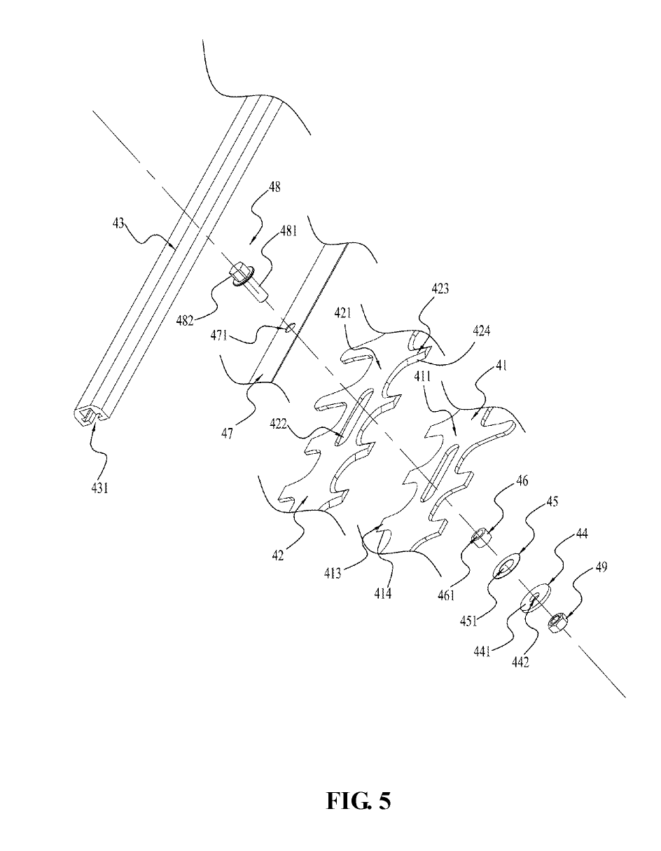

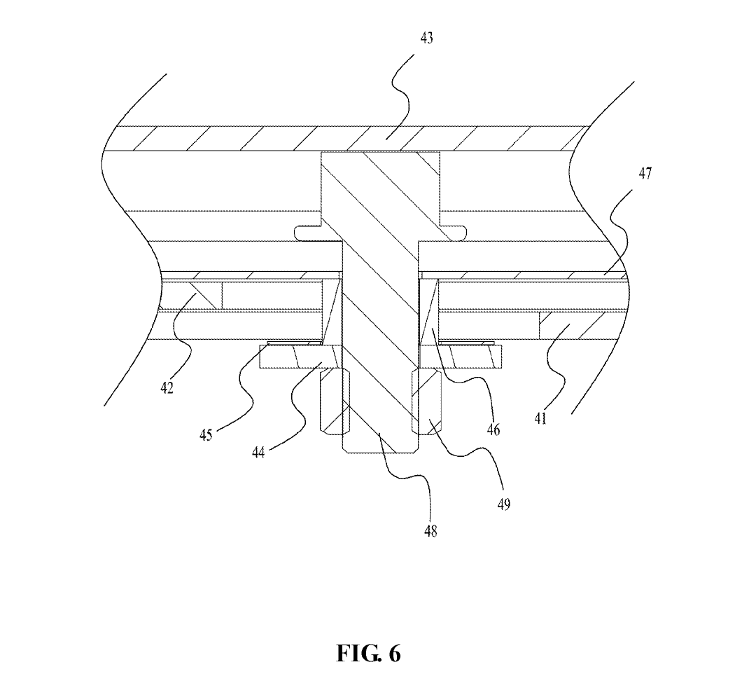

As shown in FIG. 2 to FIG. 6, the blade assembly 40 includes a first blade 41, a second blade 42, a support bar 43, limiting gaskets 44, buffer gaskets 45, bushings 46, a scaleboard 47, bolts 48 and nuts 49.

The support bar 43 is configured to install the first blade 41 and the second blade 42. The support bar 43 is fixed to the housing 20. The support bar 43 extends along a longitudinal direction (first direction) 101. The motor 10 drives the first blade 41 to make reciprocating motion along the longitudinal direction 101. As an option, the second blade 42 is static relative to the support bar 43, and the first blade 41 makes reciprocating motion relative to the second blade 42 for cutting.

In a further example, the second blade 42 may move relative to the support bar 43. The motor 10 drives the second blade 42 to make reciprocating motion along the longitudinal direction 101. The first blade 41 and the second blade 42 make reciprocating motion relative to the support bar 43, and the first blade 41 makes reciprocating motion relative to the second blade 42. The first blade 41 and the second blade 42 make reciprocating motion simultaneously, thereby realizing high cutting efficiency.

The first blade 41 includes a first substrate 411 and a plurality of first cutting portions 413. The first substrate 411 extends along the longitudinal direction 101. The first substrate 411 is formed with a plurality of first installing holes 412 extending through the first blade 41 along a predetermined direction (second direction) 102. The predetermined direction 102 is substantially perpendicular to the longitudinal direction 101. The plurality of first cutting portions 413 are connected to the first substrate 411. The first cutting portions 413 and the first substrate 411 are used as a whole. The first cutting portions 413 are formed with first cutting edges 414 for cutting. The first cutting portions 413 extend along a transverse axis 103 from the first substrate 411. The transverse axis 103 is substantially perpendicular to the predetermined direction 102 and the longitudinal direction 101. The first cutting portions 413 may be arranged on one side of the first substrate 411, and may also be arranged on both sides of the first substrate 411. In the illustrated embodiment, the plurality of first cutting portions 413 are arranged on both sides of the first substrate 411.

The second blade 42 includes a second substrate 421 and a plurality of second cutting portions 423. The second substrate 421 extends along the longitudinal direction 101. The second substrate 421 is formed with a plurality of second installing holes 422 extending through the second blade 42 along the predetermined direction 102. The plurality of second cutting portions 423 are connected to the second substrate 421. The second cutting portions 423 and the second substrate 421 are used as a whole. The second cutting portions 423 are formed with second cutting edges 424 for cutting. The second cutting portions 423 extend along the transverse axis 103 from the second substrate 421. The plurality of second cutting portions 423 are arranged on both sides of the second substrate 421.

Sizes of the first installing hole 412 and the second installing hole 422 in the longitudinal direction 101 are greater than a size in the transverse axis 103.

The limiting gasket 44 is configured to limit positions of the first blade 41 and the second blade 42 in the predetermined direction 102. The first blade 41 and the second blade 42 are arranged between the limiting gasket 44 and the support bar 43. The limiting gasket 44 is formed with a limiting plane 441. A projection of the limiting plane 441 in a plane perpendicular to the predetermined direction 102 at least partially exceeds a projection of the first installing hole 412 in the plane perpendicular to the predetermined direction 102. In the illustrated example, the projection of the limiting plane 441 in the plane perpendicular to the predetermined direction 102 exceeds the projection of the first installing hole 412 in the plane perpendicular to the predetermined direction 102 along the transverse axis 103. The limiting gasket 44 cannot penetrate through the first installing hole 412, thereby achieving that the limiting plane 441 limits the position of the first blade 41 in the predetermined direction 102. Namely, the limiting gasket 44 is used as a limiting element. The limiting gasket 44 is formed with a first fixing hole 442.

The bolt 48 includes a screw rod 481 provided with screw thread and a head 482 arranged on one end of the screw rod 481. The screw rod 481 of the bolt 48 penetrates through the first installing hole 412 and the second installing hole 422 along the predetermined direction 102. Namely, the screw rod 481 of the bolt 48 is used as a connecting rod. The screw rod 481 of the bolt 48 penetrates through the first fixing hole 442. In other words, the screw rod 481 of the bolt 48 successively penetrates through the second installing hole 422, the first installing hole 412 and the first fixing hole 442. The first blade 41 is arranged between the second blade 42 and the limiting gasket 44. The limiting gasket 44 has a fixed position relative to the screw rod 481 of the bolt 48.

The nut 49 is combined to the screw rod 481. The bolt 48 is matched with the nut 49 for installing the first blade 41 and the second blade 42 to the support bar 43. The first blade 41 and the second blade 42 are located between the nut 49 and the head 482 of the bolt 48. The bolt 48 and the nut 49 fix the limiting gasket 44.

The buffer gasket 45 is formed with a connecting hole 451. The screw rod 481 of the bolt 48 penetrates through the connecting hole 451. The buffer gasket 45 can move relative to the screw rod 481 of the bolt 48. Specifically, the screw rod 481 of the bolt 48 is connected to the limiting element after successively penetrating through the second installing hole 422, the first installing hole 412 and the connecting hole 451 along the predetermined direction 102. The first blade 41 is arranged between the buffer gasket 45 and the second blade 42. The buffer gasket 45 is arranged between the first blade 41 and the limiting gasket 44. A distance from the limiting plane 441 to the first blade 41 is greater than a thickness of the buffer gasket 45.

In a movement process of the first blade 41, the first blade 41 is deformed under external force or due to vibration of the first blade 41, and the action force of the first blade 41 is transmitted to the buffer gasket 45. Since the buffer gasket 45 can move freely, the action force of the first blade 41 cannot be directly transmitted to the bolt 48 or the nut 49. Specifically, the first blade 41 under the external force drives the buffer gasket 45 to move relative to the limiting gasket 44. The action force of the first blade 41 is transmitted to the limiting gasket 44 after buffered through the buffer gasket 45. The limiting gasket 44 keeps relatively static with the bolt 48 and the nut 49, thereby avoiding driving the nut 49 to rotate relative to the bolt 48 due to rotation of the limiting gasket 44 driven by action force of the first blade 41 directly transmitted to the limiting gasket 44, so as to avoid looseness and separation of the nut 49 and the bolt 48.

Specifically, the thickness of the buffer gasket 45 is less than the thickness of the limiting element. The thickness of the buffer gasket 45 is small, so that the buffer gasket 45 is easy to move relative to the bushing 46 or the limiting gasket 44. The nut 49 can be effectively prevented from loosening. The thickness of the limiting gasket 44 is large, so that the limiting gasket 44 is difficult to deform, thereby effectively locking the bushing 46 and limiting the positions of the first blade 41 and the second blade 42. Specifically, the thickness of the buffer gasket 45 is greater than or equal to 0.1 mm and less than or equal to 1 mm. The thickness of the limiting gasket 44 is greater than 1 mm and less than or equal to 5 mm. The surface roughness of the buffer gasket 45 is less than or equal to 0.8 um. The buffer gasket 45 has a relatively smooth surface, and is small in thickness and light in weight, so that the buffer gasket 45 can move smoothly relative to the limiting gasket 44. The hardness of the buffer gasket 45 is greater than or equal to 30HRC, and the buffer gasket 45 has good wear resistance to prevent the buffer gasket 45 from being worn.

The bushing 46 is formed with a second fixing hole 461. The screw rod 481 of the bolt 48 penetrates through the second fixing hole 461 and the first fixing hole 442. Namely, the bushing 46 is sleeved on a periphery of the screw rod 481. The bushing 46 successively penetrates through the first installing hole 412, the second installing hole 422 and the connecting hole 451 along the predetermined direction 102. The buffer gasket 45 is movably sleeved on the periphery of the bushing 46. The bolt 48 is matched with the nut 49 for fixing the bushing 46 to the support bar 43. One end of the bushing 46 contacts with the limiting plane 441. The bushing 46 is arranged between the limiting plane 441 and the support bar 43. The periphery of the bushing 46 is formed into a cylindrical surface. The connecting hole 451 of the buffer gasket 45 is circular. A diameter of the connecting hole 451 of the buffer gasket 45 is greater than a diameter of the bushing 46. The buffer gasket 45 can rotate relative to the bushing 46. The buffer gasket 45 is rotatably sleeved on the periphery of the bushing 46. The limiting gasket 44 is arranged between the bushing 46 and the nut 49. The limiting gasket 44 is clamped by the bushing 46 and the nut 49.

The scaleboard 47 is arranged between the bushing 46 and the support bar 43. The scaleboard 47 is formed with third fixing holes 471. The screw rod 481 of the bolt 48 penetrates through the third fixing hole 471. The scaleboard 47 is constructed into a sheet type part. Both end surfaces of the scaleboard 47 respectively contact with the bushing 46 and the support bar 43. Both end surfaces of the bushing 46 respectively contact with the limiting gasket 44 and the scaleboard 47. The limiting gasket 44 and the scaleboard 47 limit movement ranges of the first blade 41 and the second blade 42 in the predetermined direction 102. The hardness of the scaleboard 47 is greater than the hardness of the support bar 43. In a movement process of the second blade 42, the second blade 42 and the scaleboard 47 generate friction. The scaleboard 47 is arranged between the second blade 42 and the support bar 43, thereby preventing the second blade 42 from contacting with the support bar 43 and causing abrasion of the support bar 43. Specifically, the support bar 43 is made of aluminum. The scaleboard 47 is made of iron.

The support bar 43 is formed with an installing groove 431, and the head 482 of the bolt 48 is arranged in the installing groove 431. The head 482 of the bolt 48 is combined with the installing groove 431 so that the bolt 48 cannot rotate along the predetermined direction 102, which is convenient for rotating the nut 49 to a rod of the bolt 48. The installing groove 431 penetrates through the support bar 43 along the longitudinal direction 101. The scaleboard 47 is arranged between the support bar 43 and the bushing 46, thereby increasing a stressed area between the bushing 46 and the support bar 43.

As an alternative example, the limiting gasket may be omitted. The nut forms the limiting plane. In other words, the nut is used as the limiting element. Or the limiting gasket and the nut are integrally formed as the limiting element. As a specific example, the nut is a flange nut.

As another alternative example, the bushing may not be omitted. In other words, the bushing and the bolt are integrally formed as one part. As a specific example, the screw rod of the bolt includes a thick portion and a thin portion. A diameter of the thick portion is greater than a diameter of the thin portion. The nut is combined with the thin portion. The thick portion penetrates through the first installing hole of the first blade, the second installing hole of the second blade and the connecting hole of the buffer gasket.

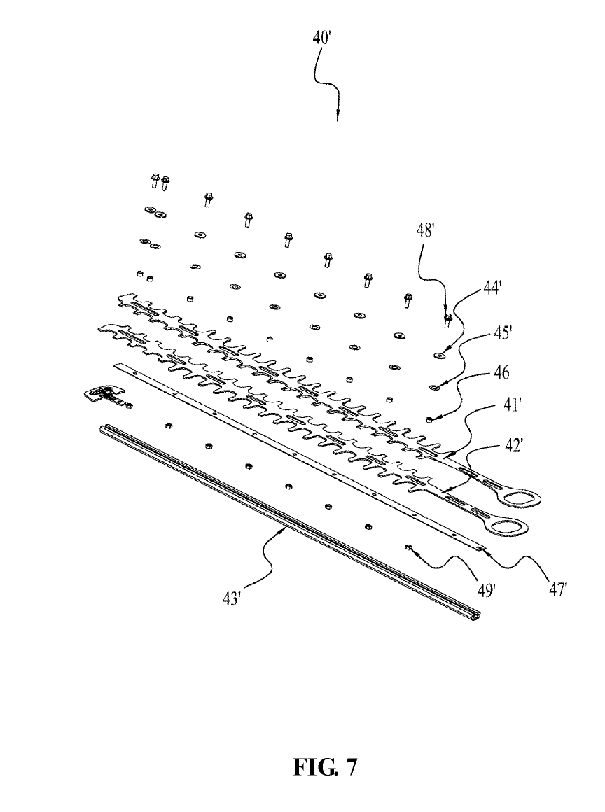

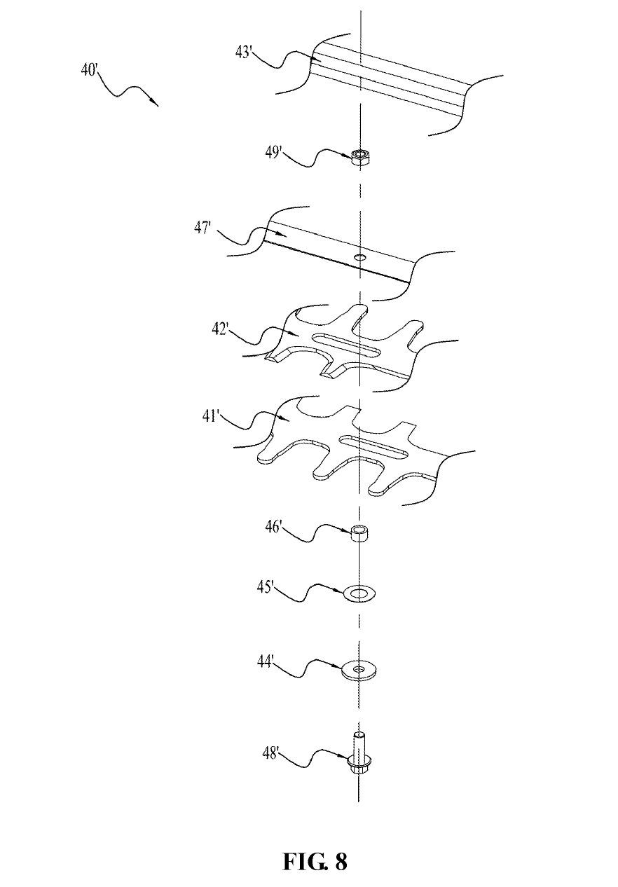

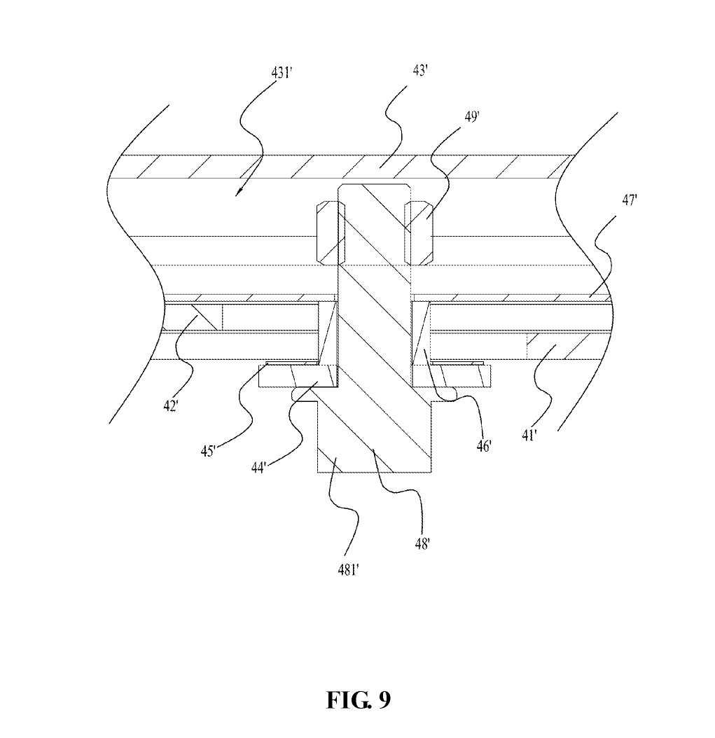

As shown in FIG. 7 to FIG. 9, the blade assembly 40′ includes a first blade 41′, a second blade 42′, a support bar 43′, limiting gaskets 44′, buffer gaskets 45′, bushings 46′, a scaleboard 47′, bolts 48′ and nuts 49′. The first blade 41′, the second blade 42′, the support bar 43′, the limiting gaskets 44′, the buffer gaskets 45′, the bushings 46′, the scaleboard 47′, the bolts 48′ and the nuts 49′ in FIG. 7 to FIG. 9 are identical in structure with the first blade 41, the second blade 42, the support bar 43, the limiting gaskets 44, the buffer gaskets 45, the bushings 46, the scaleboard 47, the bolts 48 and the nuts 49 in FIG. 2 to FIG. 6. Relative positions and connecting relationships of the first blade 41′, the second blade 42′, the support bar 43′, the limiting gaskets 44′, the buffer gaskets 45′, the bushings 46′ and the scaleboard 47′ in FIG. 7 to FIG. 9 are identical with relative positions and connecting relationships of the first blade 41, the second blade 42, the support bar 43, the limiting gaskets 44, the buffer gaskets 45, the bushings 46 and the scaleboard 47 in FIG. 2 to FIG. 6.

Compared with the positions of the bolts 48 and the nuts 49 in FIG. 2 to FIG. 6, the positions of the bolts 48′ and the nuts 49′ in FIG. 7 to FIG. 9 are opposite. Namely, the nut 49′ can be combined with the installing groove 431′ of the support bar 43′, and the nut 49′ is arranged in the installing groove 431′. The limiting gasket 44′ is arranged between the bushing 46′ and the head 482′ of the bolt 48′.

The above shows and describes a basic principle, main features and advantages of the disclosure. Those skilled in the art should understand that above embodiments do not limit the disclosure in any form. Technical solutions obtained by adopting equivalent replacements or equivalent transformations fall within a protection scope of the disclosure.

What is claimed is:

1. A hedge trimmer, comprising:
a first blade formed with a plurality of first cutting edges and a plurality of first installing holes extending through the first blade along a predetermined direction;
a second blade formed with a plurality of second cutting edges and a plurality of second installing holes extending through the second blade along the predetermined direction;
a support bar configured to install the first blade and the second blade and extending along a longitudinal direction perpendicular the predetermined direction;
a motor capable of driving the first blade to make a reciprocating motion along the longitudinal direction;
a plurality of limiting elements wherein each limiting element is provided with a limiting plane and a projection of the limiting plane in a plane perpendicular to the predetermined direction at least partially exceeds a projection of one of the first installing holes in the plane perpendicular to the predetermined direction;
a plurality of buffer gaskets each of which is formed with a connecting hole; and
a plurality of connecting rods each of which is connected to one of the limiting elements after successively penetrating through one of the second installing holes, one of the first installing holes and the connecting hole along the predetermined direction, wherein a distance from the limiting plane to the first blade is greater than a thickness of one of the buffer gaskets.

2. The hedge trimmer according to claim 1, further comprising a plurality of bushings each of which is formed with a second fixing hole, wherein each of the bushings successively penetrates through one of the second installing holes, one of the first installing holes and the connecting hole along the predetermined direction, one end of each of the bushings contacts with the limiting plane, the connecting rod penetrates through the second fixing hole along the predetermined direction, and each of the bushings is arranged between the limiting plane and the support bar.

3. The hedge trimmer according to claim 2, further comprising a scaleboard arranged between each of the bushings and the support bar, wherein the scaleboard is formed with third fixing holes, the connecting rod penetrates through one of the third fixing holes, and both end surfaces of the scaleboard respectively contact with the bushings and the support bar.

4. The hedge trimmer according to claim 3, wherein a hardness of the scaleboard is greater than a hardness of the support bar.

5. The hedge trimmer according to claim 1, wherein the limiting elements are gaskets, each of the limiting elements is formed with a first fixing hole, the connecting rod penetrates through the first fixing hole, and a thickness of each of the buffer gaskets is less than a thickness of each of the limiting elements.

6. The hedge trimmer according to claim 1, wherein a hardness of each of the buffer gaskets is greater than or equal to 30HRC.

7. The hedge trimmer according to claim 1, wherein a surface roughness of each of the buffer gaskets is smaller than 0.8 um.

8. A hedge trimmer, comprising:
a first blade formed with a plurality of first cutting edges and a plurality of first installing holes;
a second blade formed with a plurality of second cutting edges and a plurality of second installing holes;
a support bar configured to install the first blade and the second blade and extending along a first direction;
a motor for driving the first blade to make a reciprocating motion along the longitudinal direction wherein the first plurality of installing holes penetrate through the first blade along a second direction perpendicular to the longitudinal direction and the plurality of second installing holes penetrate through the second blade along the second direction;
a plurality of limiting gaskets each of which is provided with a limiting plane, wherein a projection of the limiting plane in a plane perpendicular to the second direction at least partially exceeds a projection of one of the first installing holes in the plane perpendicular to the second direction and each of the limiting gaskets is formed with a first fixing hole;
a plurality of buffer gaskets each of which is formed with a connecting hole;
a plurality of bushings each of which is formed with a second fixing hole, wherein each of the bushings successively penetrates through one of the second installing holes, one of the first installing holes and the connecting hole along the second direction;
a plurality of bolts each of which comprises a screw rod provided with screw thread and a head arranged on one end of the screw rod, wherein the screw rod of each of the bolts penetrates through the first fixing hole and the second fixing hole along the second direction; and
a plurality of nuts each of which is combined to the screw rod;
wherein the limiting gaskets are located between the nuts and the bushings, both ends of each of the limiting gaskets respectively contact with one of the nuts and one of the bushings, and a distance from the limiting plane to the first blade is greater than a thickness of each of the buffer gaskets.

9. The hedge trimmer according to claim 8, wherein the support bar is formed with an installing groove matched with the heads of the bolts and the heads of the bolts are arranged in the installing groove.

10. The hedge trimmer according to claim 8, wherein a hardness of each of the buffer gaskets is greater than or equal to 30HRC.

11. The hedge trimmer according to claim 8, wherein a surface roughness of each of the buffer gaskets is smaller than 0.8 um.

12. A hedge trimmer, comprising:
a motor;
a first blade formed with a plurality of first cutting edges and first installing holes;
a second blade formed with a plurality of second cutting edges and second installing holes;
a support bar configured to install the first blade and the second blade and extending along a longitudinal direction, wherein the motor drives the first blade to make reciprocating motion along the longitudinal direction, the first blade is formed with the first installing holes penetrating through the first blade along a predetermined direction perpendicular to the longitudinal direction, and the second blade is formed with the second installing holes penetrating through the second blade along the predetermined direction;
a plurality of limiting gaskets each of which is provided with a limiting plane, wherein a projection of the limiting plane in a plane perpendicular to the predetermined direction at least partially exceeds a projection of one of the first installing holes in the plane perpendicular to the predetermined direction and each of the limiting gaskets is formed with a first fixing hole;
a plurality of bushings each of which is formed with a second fixing hole;
a plurality of bolts each of which comprises a screw rod provided with screw thread and a head arranged on one end of the screw rod, wherein the screw rod of each of the bolts penetrates through the first fixing hole and the second fixing hole along the predetermined direction;
a plurality of buffer gaskets each of which is formed with a connecting hole; and
a plurality of nuts each of which is combined to the screw rod;
wherein each of the bushings successively penetrates through one of the second installing holes, one of the first installing holes and the connecting hole along the predetermined direction, a distance from the limiting plane to the first blade is greater than a thickness of each of the buffer gaskets, each of the limiting gaskets is located between the head and one of the bushings, and both ends of each of the limiting gaskets respectively contact with the head and one of the bushings.

13. The hedge trimmer according to claim 12, wherein a hardness of each of the buffer gaskets is greater than or equal to 30HRC.

14. The hedge trimmer according to claim 12, wherein a surface roughness of each of the buffer gaskets is smaller than 0.8 um.
